(19) United States
(12) Patent Application Publication
(10) Pub. No.: US 2005/0121917 A1
(43) Pub. Date: Jun. 9, 2005

(54) Method comprising electricity transmission, hydrogen productin and its transportation, from ocean and/or tidal current power generation apparatus, and control and moorage of ocean and/or tidal current power generation apparatus

(76) Inventor: Nozomu Kikuchi, Los Angeles, CA (US)

Correspondence Address: Nozomu KIKUCHI, Suite 1700, 350 South Grand Avenue, Los Angeles, CA, 90071, US

(21) Appl. No.: 11/006,649

(22) Filed: Dec. 7, 2004

(30) Foreign Application Priority Data
Dec. 9, 2003 (JP) 2003-436366

(51) Int. Cl. H02P 9/04; F03B 13/10; F03B 13/12; F03B 13/00

(52) U.S. Cl. 290/53

(57) ABSTRACT

This invention comprises electricity transmission and hydrogen production and its transportation from ocean and/or tidal current power generation apparatus, as well as control and moorage of ocean and/or tidal current power generation apparatus. Concretely speaking, the invention comprises interconnection of electricity from multiple detachable ocean and/or tidal current power generation apparatuss, via weights attached to the seabed, electricity transmission to land and/or sea surface, and hydrogen production and its transportation. Hydrogen can be temporarily stored. Surplus electricity can be used as it is. Propellered ocean and/or tidal current power generation apparatus comprises stabilizing function, submergible function for control, and detachable function to weight attached to the seabed.

### CROSS-REFERENCE TO RELATED APPLICATIONS

U.S. patent Documents
U.S. Pat. No. 6,406,251 Philippe Vauthier Jun. 18, 2002
U.S. Pat. No. 6,139,255 Philippe Vauthier Oct. 31, 2000
U.S. Pat. No. 5,051,059 Peter T. Rademacher Sep. 24, 1991
U.S. Pat. No. 6,759,757 Steven Campbell Jul. 6, 2004

### STATEMENT REGARDING FEDERALLY SPONSORED RESEARCH OR DEVELOPMENT

No

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

No

### BACKGROUND OF THE INVENTION

Traditional method of energy transmission from ocean and/or tidal current power generation apparatus involves undersea power transmission to land via cables or lacks sufficient experimentation. Traditional mooring methods for ocean and/or tidal current power generation apparatus entail anchoring or attachment to the seabed. Moreover, the traditional method of controling the apparatus during mooring utilizes buoyancy or has not sufficiently considered more effective alternatives.

Based on the technology and methodology described above, however, offshore power generation suitable for ocean and/or tidal current power generation is generally difficult in terms of cost and technology. Furthermore, energy transmission from ocean and/or tidal current power generation apparatus by way of undersea power transmission cables to land, previously believed to be the most promising method, results in substantial transmission loss, especially when the apparatus is situated far from the shore. In addition, the method requires additional costs for maintenance and does not provide ample flexibility in response to changes in current speed resulting from fluctuations in the flow channel. These problems are particularly apparent when commercializing ocean and/or tidal current power generation operations on a large scale in the interest of efficiency.

The traditional control method for offsetting drift and directional deviation of the ocean and/or tidal current power generation apparatus in response to fluctuations in flow channel is bouyancy or lacks sufficient consideration. This control method does not effectively respond to fluctuations in flow channel. The traditional mooring method for such apparatus are disadvantageous in that they are prone to drifting, especially when these apparatus are commericalized on a large scale to maximize efficiency. In addition, there are difficulties in terms of cost and technology associated with the traditional method of mooring these apparatus because, in the event of movement, the undersea power transmission cable must be rerouted offshore at additional cost to an area suitable for ocean and/or tidal current power generation. Once the apparatus is attached to the seabed, it is not possible to adjust to fluctuations in flow channel. Furthermore, because locations suitable for generation are often in the deep sea, difficulties arise when conducting maintenance and repairs that require docking of the apparatus.

Although it exists, has huge energy compared to other renewable energies, in seas close to Japan, and dose not emit Co2 that could affect global warming, ocean current and/or tidal current energy has not been utilized at least on industry, even its potential.

At present, nuclear power generation and thermal power generation by the fossil fuel, which could be replaced and/or complemented by ocean and/or tidal current power generation, are suffering from disadvantage in varying ways.

As mentioned previously like lack of technological and methodological breakthroughs, and its disadvantage of costs, ocean current and/or tidal current energy has not been utilized at least on industry.

Therefore, it is an object of the invention to provide accumulation and transmission method of energy from ocean and/or tidal current power generation apparatus, with actual, large scale and networked utilization on industry.

### BRIEF SUMMARY OF THE INVENTION

This invention comprises electricity transmission and hydrogen production and its transportation from ocean and/or tidal current power generation apparatus, as well as control and moorage of ocean and/or tidal current power generation apparatus.

Traditional method for transporting energy generated from ocean and/or tidal current power generation apparatus presents problems related to transmission loss and maintenance, especially when the apparatus is far from the shore. Moreover, the production of this electricity is unstable.

With respect to the anchoring system, the traditional mooring methods for ocean and/or tidal current power generation apparatuses are prone to drifting.

In addition, the traditional mooring methods for ocean and/or tidal current power generation apparatus are disadvantageous because the undersea power transmission cables must be rerouted offshore in the event that the apparatus is relocated. With the traditional method, attaching the appartus to the seabed presents difficulties when relocating to other areas in the sea and also complicates maintenance. Until now, methods for controling ocean and/or tidal current power generation apparatus have not been sufficiently explored.

The invention comprises interconnection of electricity from multiple detachable ocean and/or tidal current power generation apparatuss, via weights attached to the seabed, electricity transmission to land and/or sea surface, and hydrogen production and its transportation.

Hydrogen can be temporarily stored. Surplus electricity can be used as it is.

Propellered ocean and/or tidal current power generation apparatus comprises stabilizing function, submergible function for control, and detachable function to weight attached to the seabed.

### BRIEF DESCRIPTION OF THE SEVERAL VIEWS OF THE DRAWING

Preferred configurations of said invention will be described concretely hereafter in FIGS. 1 and 2.

FIG. 1 is an oblique perspective diagram showing one configuration for the production of hydrogen from electricity and its transportation.

FIG. 2 is an oblique perspective diagram showing one configuration for an ocean and/or tidal current power generation apparatus.

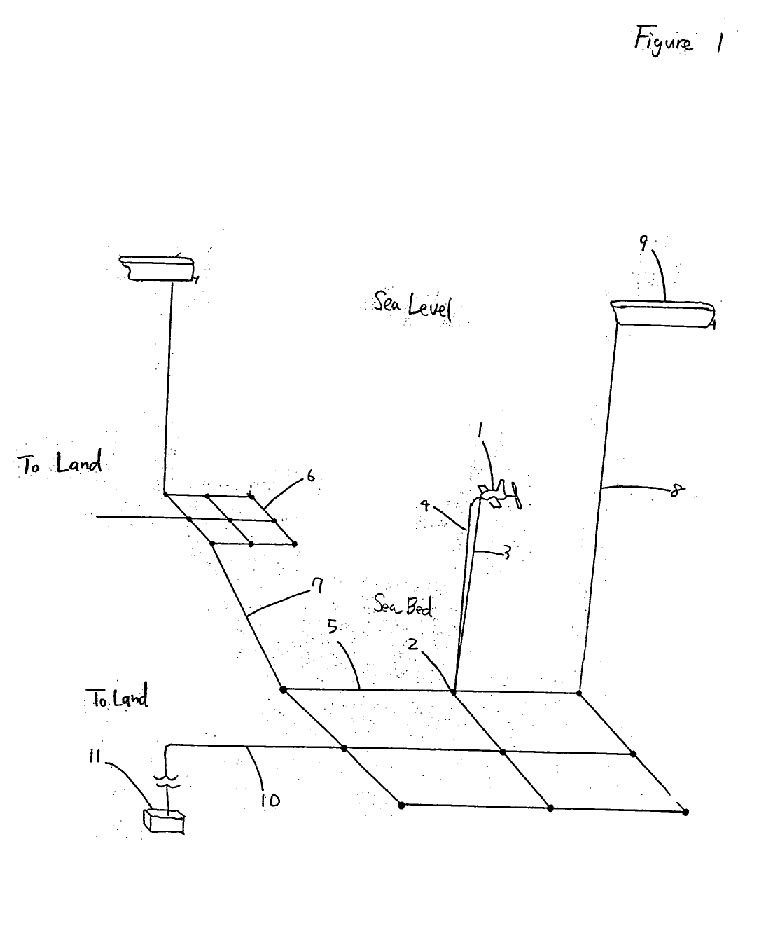

### FIG. 1

1 Power generation apparatus
2 Detachable weights linked to power generation apparatus to prevent drift
3 Anchor cables
4 Power transmission cable
5 Undersea power transmission cable linked to other power generation apparatus
6 Other generation network group
7 Undersea power transmission cable linked to other generation network groups
8 Power transmission cable linked to hydrogen production mobile objects
9 Hydrogen production mobile objects used in power generation
10 Power transmission cable linked to hydrogen production plants on land
11 Hydrogen production plants on land

Storage apparatus and/or facilities can be employed, and electricity may be conducted through a buoy to the hydrogen production mobile objects if necessary. Surplus electricity can be used as it is.

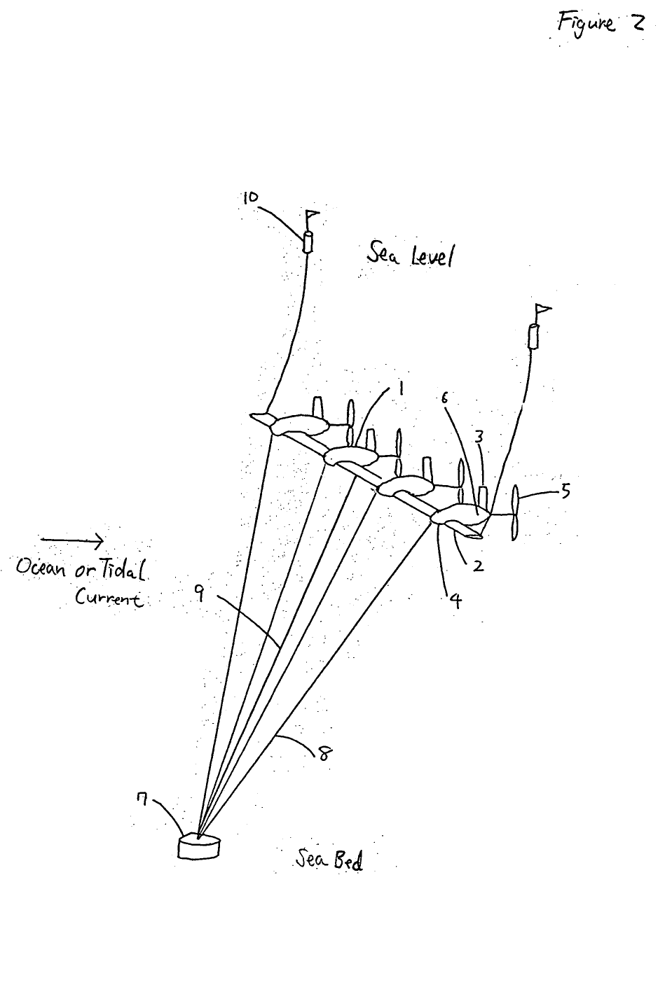

### FIG. 2

1 propelled power generation apparatus
2 horizontal stabilizer for control
3 vertical stabilizer for control
4 ballast
5 external propeller for electricity generation
6 power generation apparatus
7 detachable weights linked to power generation apparatus to prevent drift
8 anchor cables
9 power transmission cable
10 buoy

Any shape of stabilizer and/or ballast for control can be used.

Stabilizer can have a ruder.

### DETAILED DESCRIPTION OF THE INVENTION

The first invention is a method that comprises interconnection of electricity from multiple detachable ocean and/or tidal current power generation apparatus via weights attached to the seabed, electricity transmission, and hydrogen production and its transportation.

Electricity can also be transmitted via buoy to hydrogen production mobile objects on the sea surface. Hydrogen can be stored if necessary. Surplus electricity can be used as is. Generating apparatus can be wind powered.

The second invention is a propelled ocean and/or tidal current power generation apparatus comprising a stabilizing function and a submerging function for control, as well as function allowing detachment from the weights attached to the seabed.

These methods improve cost effectiveness and enhance the technology facilitating the use of an ocean current and/or a current.

The first invention, concerned with the mode of transport for energy generated by ocean and/or tidal current power generation apparatus, decreases the distance of power transmission and reduces both undersea power transmission cable maintenance costs as well as transmission loss by employing hydrogen. Furthermore, with respect to its anchoring system, the first invention eliminates the need to move undersea transmission cables in the event of changes in oceanic conditions resulting from fluctuations in flow channel. Moreover, the invention addresses stability issues associated with electricity production from ocean and/or tidal current power generation apparatus, which are attributed to current speed changes reflecting fluctuations in flow channel. Furthermore, the invention eases the difficulties in storing electricity and facilitates a stable supply of ocean and/or tidal current energy.

The second invention provides an enhanced method of controling the power generation apparatus by fixing weights to the seabed, thereby facilitating easier response to fluctuations in flow channel and reducing drifting effect even when the power generation apparatus is enlarged for greater efficiency. The detachable ocean and/or tidal current power generation apparatus allows for easier maintenance as well as the identification of areas suitable for power generation because ocean and/or tidal current is usually strong but deep sea in the offing.

These improvements contribute to the large-scale operations necessary to commercialize ocean and/or tidal current energy effectively, and reduce the price of hydrogen. Ocean current and/or tidal current energy is stable and abundant compared to other renewable energies, and its consumption does result in Co2 emissions that could affect global warming. Moreover, this energy is available in the seas proximate to Japan. It will enhance industry and could replace nuclear power generation and thermal power generation, which uses fossil fuel.

1. Method comprising interconnection of electricity from multiple detachable ocean and/or tidal current power generation apparatus via weights attached to the seabed, electricity transmission, and hydrogen production and its transportation.

2. Ocean and/or tidal current power generation apparatus comprising stabilizing function, submerging function for control, and allowing detachment from weights attached to the seabed as defined in claim 1.
